(19) United States
(12) Patent Application Publication
(10) Pub. No.: US 2024/0376956 A1
(43) Pub. Date: Nov. 14, 2024

(54) DAMPING FORCE ADJUSTABLE SHOCK ABSORBER, DAMPING VALVE, AND SOLENOID

(71) Applicant: Hitachi Astemo, Ltd., Hitachinaka-shi, Ibaraki (JP)

(72) Inventor: Kosuke KADOKURA, Hitachinaka-shi, Ibaraki (JP)

(21) Appl. No.: 18/691,993

(22) PCT Filed: Sep. 9, 2022
(86) PCT No.: PCT/JP2022/033843

§ 371 Date: Mar. 14, 2024

(30) Foreign Application Priority Data
Nov. 10, 2021 (JP) 2021-183426

(51) Int. Cl. F16F 9/46; F16F 9/18; F16F 9/34; G05D 16/20; H01F 7/16

(52) U.S. Cl. CPC F16F 9/465; F16F 9/185; F16F 9/34; G05D 16/2013; H01F 7/1607; F16F 2222/12; F16F 2228/001; F16F 2228/066; F16F 2230/18

(57) ABSTRACT

When a pilot valve is actuated, and an actuating rod to which a valve body is fixed moves in an axial direction, hydraulic liquid of an equivalent amount to a volume of a portion of the actuating rod which enters and retracts from a valve body back-pressure chamber moves between a pilot chamber and the valve body back-pressure chamber through an orifice (volume compensation). At this time, the damping that is generated by the hydraulic liquid passing through the orifice acts on the valve body, which restrains self-induced vibrations (chattering) of the pilot valve.

### TECHNICAL FIELD

The invention relates to a damping force adjustable shock absorber that adjusts damping force by controlling a hydraulic fluid flow generated by strokes of a piston rod, a damping valve used in the damping force adjustable shock absorber, and a solenoid that adjusts valve-opening pressure of the damping valve.

### BACKGROUND ART

Patent Literature 1 discloses a shock absorber 1 (hereinafter referred to as a conventional damping force adjustable shock absorber) comprising an electromagnetic damping force adjustment device 17 (pressure control valve) including a valve body 32 that is seated on a valve seat portion 26E (seat surface), a solenoid 33 that adjusts the valve-opening pressure of the valve body 32, and a back-pressure chamber 47 (valve body back-pressure chamber) that makes inner pressure act in a direction biasing the valve body 32 to the valve seat portion 26E side.

### CITATION LIST

### Patent Literature

PTL 1: Japanese Unexamined Patent Application Publication (Kokai) No. 2017-211062

### SUMMARY OF INVENTION

### Technical Problem

The conventional damping force adjustable shock absorber is so configured that, when the pressure in a pilot chamber reaches a given pressure (valve-opening pressure) and opens a pilot valve, hydraulic liquid flows out of the pilot chamber into a reservoir through a flow path arranged at the outer periphery of a valve mechanism portion. However, if the hydraulic liquid that flows out of the pilot chamber is increased in flow rate, the pilot valve makes self-induced vibrations (fluid-induced vibrations) in some cases. Such self-induced vibrations (chattering) of the pilot valve are the cause of noises generated by the damping force adjustable shock absorber and therefore need to be restrained.

An issue of the invention is to provide a damping force adjustable shock absorber in which noises caused by self-induced vibrations of a pilot valve is restrained from being generated, a damping valve used in the damping force adjustable shock absorber, and a solenoid that adjusts valve-opening pressure of the damping valve.

### Solution to Problem

A damping force adjustable shock absorber of the invention is a damping force adjustable shock absorber comprising a cylinder in which hydraulic fluid is sealingly contained, a piston that is slidably fitted in the cylinder, a flow path in which a hydraulic fluid flow is generated by a sliding motion of the piston fitted in the cylinder, and a pressure control valve that is provided in the flow path, the pressure control valve in which valve-opening pressure of a damping valve is adjusted by thrust force that is generated by a solenoid, the damping valve comprising a main valve configured to control the hydraulic fluid flow passing through the flow path to generate damping force, a main back-pressure chamber configured to make inner pressure act on the main valve in a valve-closing direction, and a pilot valve including a valve body that is seated on a seat surface and configured to adjust valve-opening pressure of the main valve, the solenoid comprising a shaft portion that is provided in the valve body and provided inside with a communication path extending in an axial direction, a plunger in which the shaft portion is inserted, the plunger being configured to generate thrust force biasing the valve body toward the seat surface side in response to energization of a coil, and a valve body back-pressure chamber configured to make inner pressure act in a direction biasing the valve body toward the seat surface side, wherein a first orifice is provided between the valve body back-pressure chamber and the valve body.

The damping valve of the invention is a damping valve configured to be adjusted in valve-opening pressure by thrust force generated by a solenoid, the damping valve comprising a main valve configured to control a hydraulic fluid flow to generate damping force, a main back-pressure chamber configured to make inner pressure act on the main valve in a valve-closing direction, and a pilot valve including a valve body that is seated on a seat surface and configured to adjust valve-opening pressure of the main valve, the solenoid comprising a shaft portion that is provided in the valve body and provided inside with a communication path extending in an axial direction, a plunger in which the shaft portion is inserted, the plunger being configured to generate thrust force biasing the valve body toward the seat surface side in response to energization of a coil, and a valve body back-pressure chamber configured to make inner pressure act in a direction biasing the valve body toward the seat surface side, wherein a first orifice is provided between the valve body back-pressure chamber and the valve body.

The solenoid of the invention is a solenoid configured to adjust valve-opening pressure of a damping valve, the damping valve comprising a main valve configured to control a hydraulic fluid flow to generate damping force, a main back-pressure chamber configured to make inner pressure act on the main valve in a valve-closing direction, and a pilot valve including a valve body that is seated on a seat surface and configured to adjust valve-opening pressure of the main valve, the solenoid comprising a shaft portion provided in the valve body and provided inside with a communication path extending in an axial direction, a plunger in which the shaft portion is inserted, the plunger being configured to generate thrust force biasing the valve body toward the seat surface side in response to energization of a coil, and a valve body back-pressure chamber configured to make inner pressure act in a direction biasing the valve body toward the seat surface side, wherein a first orifice is provided between the valve body back-pressure chamber and the valve body.

The damping force adjustable shock absorber, the damping valve, and the solenoid according to one embodiment of the invention make it possible to restrain the generation of noises caused by self-induced vibrations of the pilot valve.

### BRIEF DESCRIPTION OF DRAWINGS

FIG. 1 is a cross-sectional view of a damping force adjustable shock absorber according to a first embodiment.

FIG. 2 is an enlarged view of a damping force adjustment mechanism illustrated in FIG. 1.

FIG. 3 is an explanatory view of a second embodiment.

FIG. 4 is an explanatory view of a third embodiment.

### DESCRIPTION OF EMBODIMENTS

A first embodiment of the invention will be discussed with reference to the attached drawings.

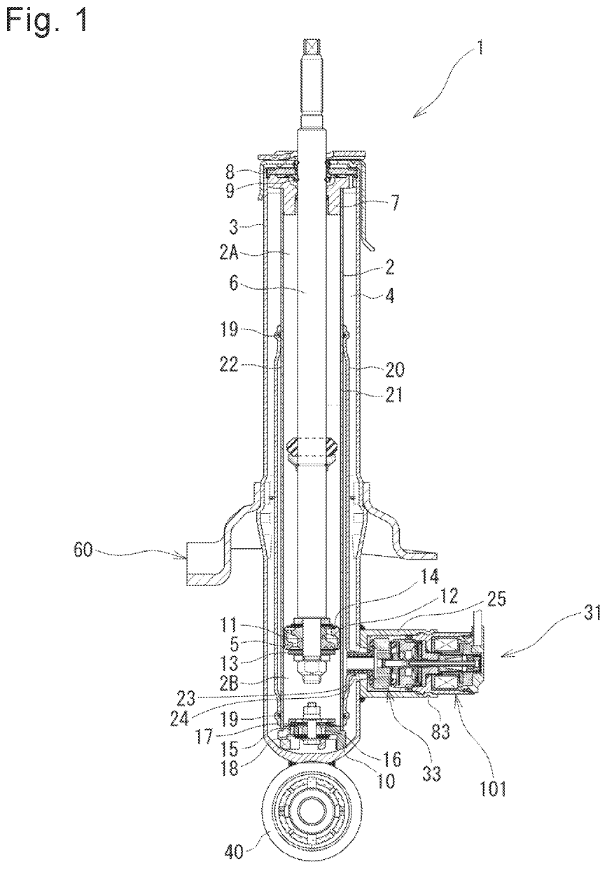

FIG. 1 is a cross-sectional view of a so-called damping force adjustable hydraulic shock absorber 1 with a horizontally-arranged control valve (hereinafter referred to as a shock absorber 1) in which a damping force adjustment mechanism 31 is horizontally arranged at a lateral portion of an outer tube 3. For the sake of convenience, a vertical direction in FIG. 1 is referred to as a vertical direction.

The shock absorber 1 has a multi-cylinder structure in which a cylinder 2 is provided inside the outer tube 3. A reservoir 4 is formed between the cylinder 2 and the outer tube 3. A piston 5 is slidably fitted in the cylinder 2 and separates an interior portion of the cylinder 2 into two chambers including a cylinder's upper chamber 2A and a cylinder's lower chamber 2B. The shock absorber 1 is coupled to the piston 5 at a lower end portion (one end portion) thereof. An upper end portion (the other end portion) of the shock absorber 1 comprises a piston rod 6 extending through the cylinder's upper chamber 2A and projecting from an opening of the outer tube 3 to the outside. A rod guide 7 is provided in an upper end portion of the cylinder 2 and extends through the piston rod 6. The cylinder's upper chamber 2A is sealed from the outside by an oil seal 9 that is mounted on a washer 8. A spring seat 60 is provided on an outer peripheral side of the outer tube 3.

The piston 5 is provided with an extension-side path 11 and a compression-side path 12 which bring the cylinder's upper chamber 2A and the cylinder's lower chamber 2B into communication. The extension-side path 11A is provided with a disc valve 13 (relief valve). The disc valve 13 is opened when pressure on the cylinder's upper chamber 2A side reaches preset pressure, to thereby release the pressure on the cylinder's upper chamber 2A side to the cylinder's lower chamber 2B side. The compression-side path 12 is provided with a disc valve 14 (check valve). The disc valve 14 allows hydraulic fluid to flow out of the cylinder's lower chamber 2B into the cylinder's upper chamber 2A.

The cylinder 2 is provided with a base valve 10 at a lower end portion thereof. The base valve 10 separates the cylinder's lower chamber 2B and the reservoir 4 from each other. The base valve 10 is provided with an extension-side path 15 and a compression-side path 16 which bring the cylinder's lower chamber 2B and the reservoir 4 into communication. The extension-side path 15 is provided with a disc valve 17 (check valve) that allows hydraulic fluid to flow from the reservoir 4 side to the cylinder's lower chamber 2B side. The compression-side path 16 is provided with a disc valve 18 (relief valve). The disc valve 18 is opened when pressure on the cylinder's lower chamber 2B side reaches preset pressure, to thereby release the pressure on the cylinder's lower chamber 2B side to the reservoir 4 side. As the hydraulic fluid, oil liquid is sealingly contained in the cylinder 2. In the reservoir 4, oil liquid and gas are sealingly contained.

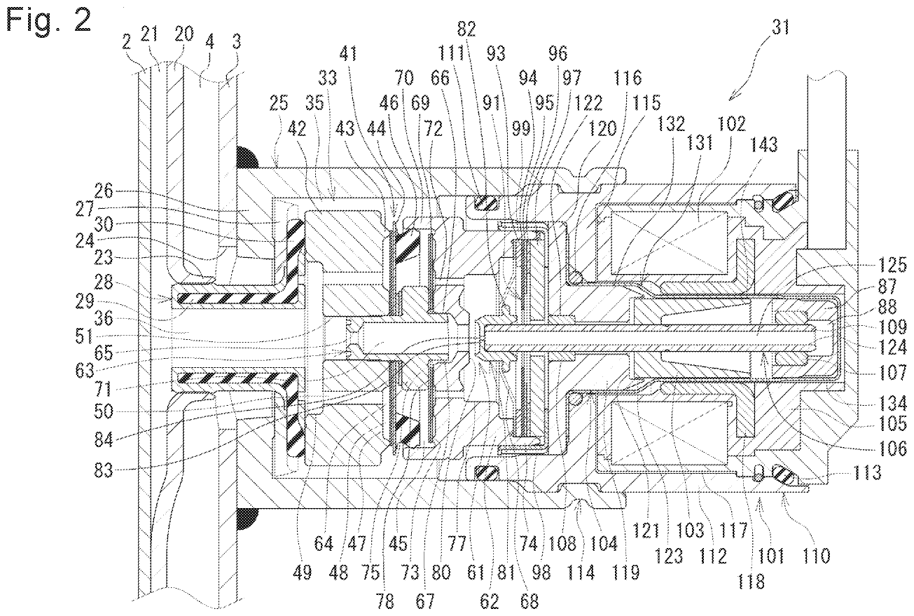

A separator tube 20 is mounted on an outer periphery of the cylinder 2 with a pair of upper and lower seal members 19, 19 intervening therebetween. An annular fluid path 21 is formed between the cylinder 2 and the separator tube 20. A path 22 is provided along an upper lateral wall of the cylinder 2 to bring the annular fluid path 21 and the cylinder's upper chamber 2A into communication. A cylindrical connection port 23 is provided in a lower lateral wall of the separator tube 20. The connection port 23 is projecting rightward in FIG. 2 (outward in a cylinder radial direction). A mounting hole 24 is provided in a lateral wall of the outer tube 3. The mounting hole 24 is coaxial with the connection port 23. The lateral wall of the outer tube 3 is further provided with a cylindrical case 25 surrounding the mounting hole 24.

As illustrated in FIG. 2, the damping force adjustment mechanism 31 (pressure control valve) is accommodated in the case 25. The damping force adjustment mechanism 31 comprises a valve mechanism portion 33 (damping valve) with which a valve component is integrally formed, and a solenoid 101 that adjusts valve-opening pressure of a pilot valve 61 (valve body 81). The valve mechanism portion 33 includes a main valve 41 of a back-pressure type, the pilot valve 61 that controls valve-opening pressure of the main valve 41, and a fail-safe valve 91 that is provided downstream of the pilot valve 61.

A joint member 28 extends through the mounting hole 24 of the outer tube 3. The joint member 28 includes a cylindrical tube portion 29 and a flange portion 30. A left-side end portion of the tube portion 29 in FIG. 2 (inward end portion in the cylinder radial direction) is inserted in the connection port 23. The flange portion 30 is provided at a peripheral edge of a right-side opening of the tube portion 29 in FIG. 2 (outward opening in the cylinder radial direction). The flange portion 30 is accommodated in the case 25. The tube portion 29 and the flange portion 30 are covered with a seal material. A left-side end surface of the flange portion 30 in FIG. 2 is in abutment against a right-side end surface of an inner flange portion 26 of the case 25 in FIG. 2. A right-side end surface of the flange portion 30 in FIG. 2 is in abutment against a left-side annular end surface of a main body 42 in FIG. 2. An outer peripheral flow path 35 in the valve mechanism portion 33 and the reservoir 4 are brought into communication with each other through a plurality of paths 27 (grooves) provided in the inner flange portion 26 of the case 25.

The valve mechanism portion 33 comprises the main body 42 having an annular shape, an annular pilot body 62, and a pilot pin 63 joining the main body 42 and the pilot body 62. An annular seat portion 43 is formed in an outer peripheral edge portion of a right-side end surface of the main body 42 in FIG. 2 (outward end surface in the cylinder radial direction). A main disc 44 is in abutment against the seat portion 43 at an outer peripheral edge portion thereof such that the outer peripheral edge portion of the main disc 44 can be seated on and separated from the seat portion 43. An inner peripheral portion of the main disc 44 is clamped between an inner peripheral portion of the main body 42 and a large diameter portion 64 of the pilot pin 63.

An annular packing 46 is provided in an outer peripheral portion of a right-side end surface of the main disc 44 in FIG. 2 (outward end surface in the cylinder radial direction). An annular recessed portion 47 is provided in a right-side end surface of the main body 42 in FIG. 2. When the main disc 44 is seated on the seat portion 43, an annular path 48 is formed between the main body 42 and the main disc 44. The annular path 48 is in communication with the outer peripheral flow path 35 of the main body 42 through an orifice (reference sign omitted) that is formed in the main disc 44. A recessed portion 49 is formed at a center of a left-side end surface of the main body 42 in FIG. 2 (inward end surface in the cylinder radial direction). The recessed portion 49 and the annular recessed portion 47 (annular path 48) located in the right-side end surface in FIG. 2 are in communication with each other through a plurality of (FIG. 2 only shows two) paths 50 formed in the main body 42.

The pilot pin 63 is formed into a shape like a bottomed cylinder that is opened at a right-side end surface in FIG. 2 (outward end surface in the cylinder radial direction). Formed in a bottom portion of the pilot pin 63 which is illustrated on the left side in FIG. 2 (located on the inner side in the cylinder radial direction) is an introduction orifice 65 (second orifice). A left-side end portion of the pilot pin 63 in FIG. 2 is press-fitted in an axial hole 51 of the main body 42. A right-side end portion of the pilot pin 63 in FIG. 2 is press-fitted in a recessed portion 66 that is formed in a left-side end surface of the pilot body 62 in FIG. 2. A plurality of (FIG. 2 only shows one) paths 67 (grooves) are formed in an outer peripheral surface of a right-side end portion of the plot pin 63 in FIG. 2. The plurality of paths 67 extend in the axial direction (right-and-left direction in FIG. 2).

The pilot body 62 is formed into a substantially bottomed cylinder-like shape which is opened at the right side in FIG. 2 (outward in the cylinder radial direction). A flexible disc 69 is provided on a left-side end surface of the pilot body 62 in FIG. 2 (inward end surface in the cylinder radial direction). The flexible disc 69 is clamped by an inner peripheral portion of the pilot body 62 and the large diameter portion 64 of the pilot pin 63. A cylindrical portion 70 is formed in an outer peripheral portion of the left-side end surface of the pilot body 62 in FIG. 2 so as to be coaxial with the pilot body 62. The packing 46 of the main valve 41 slidably abuts against an inner peripheral surface of the cylindrical portion 70. A main back-pressure chamber 45 is accordingly formed at the back side of the main disc 44. Inner pressure of the main back-pressure chamber 45 acts on the main disc 44 in a valve-closing direction (direction pushing the main disc 44 against the seat portion 43).

A plurality of (FIG. 2 only shows two) paths 72 are provided in a bottom portion of the pilot body 62 at regular intervals in a circumferential direction so as to extend in the axial direction. When the flexible disc 69 is seated on an annular seat portion 73 that is provided in the left-side end surface of the pilot body 62 in FIG. 2 (inward end surface in the cylinder radial direction), an annular path (reference sign omitted) is formed in the inside (at an inner periphery) of the seat portion 73. A left-side end of each of the paths 72 in FIG. 2 opens into the annular path. The flexible disc 69 is warped by receiving the inner pressure of the main back-pressure chamber 45, which imparts volume elasticity to the main back-pressure chamber 45.

The flexible disc 69 is configured by stacking a plurality of discs. A notch 75 is provided in an inner peripheral portion of the flexible disc 69. The notch 75 brings the paths 67 and the main back-pressure chamber 45 into communication through a disc communication path 78 (third orifice). Accordingly, oil liquid in the annular fluid path 21 is introduced into the damping force adjustment mechanism 31 through a flow path 36 (axial hole) of the joint member 28 and then introduced into the main back-pressure chamber 45 through the introduction orifice 65 (second orifice) and a pilot chamber 71. The pilot chamber 71 is a space that is defined by an internal path (axial hole) of the pilot pin 63, the bottom portion of the pilot body 62, and the valve body 81. The pilot chamber 71 includes the paths 67 and the notch 75 (path) that is formed in the inner peripheral portion of the flexible disc 69.

A recessed portion 77 opens in the right-side end surface of the pilot body 62 in FIG. 2 (outward end surface in the cylinder radial direction). Provided at a center of a bottom portion of the recessed portion 77 is an annular seat surface 80 (valve seat) against which the valve body 81 abuts in such a manner that the valve body 81 can be seated on and separated from the seat surface 80. The seat surface 80 is provided at a peripheral edge of an opening located at a center of the bottom portion of the pilot body 62, through which hydraulic fluid passes. The valve body 81 is formed to have a substantially cylindrical shape. A left-side end portion of the valve body 81 in FIG. 2 (inward end portion in the cylinder radial direction) is formed into a tapered shape. A right-side end portion of the valve body 81 in FIG. 2 (outward end portion in the cylinder radial direction) is provided with a spring receiving portion 82 having a shape like an outer flange. The valve body 81 is biased by a pilot spring 68 in a valve-opening direction (direction away from the seat surface 80, that is, rightward in FIG. 2).

A cylindrical portion 74 is formed in the right-side end portion of the pilot body 62 in FIG. 2 (outward end portion in the cylinder radial direction). Stacked on the cylindrical portion 74 are the pilot spring 68, a spacer 93, a fail-safe disc 94, a retainer 95, a spacer 96, and a washer 97, in the order from left in FIG. 2. The stacked components are fastened together by a cap 98 that is fitted onto an outer periphery of the cylindrical portion 74. In the cap 98, a path 99 (notch) is formed to bring the recessed portion 77 (valve chamber) and the outer peripheral flow path 35 of the valve mechanism portion 33 into communication.

The solenoid 101 functioning as a damping force variable actuator of the damping force adjustment mechanism 31 comprises a coil 102, a plunger 103 (movable iron core), a core 104 (fixed iron core), an overmold 117, an actuating rod 106 (shaft portion), a pair of bushes 107, 108, a back-pressure chamber forming member 87, a valve body back-pressure chamber 88, a cap member 131, and other like elements. The solenoid 101 is, for example, a proportional solenoid.

A solenoid case 110 is formed into a shape like a cylinder that is coaxial with an axis of the actuating rod 106 (axis of the solenoid 10; hereinafter referred to as axis). The solenoid case 110 is formed of a magnetic body (magnetic material) as a yoke member having a substantially cylindrical shape. When energized, the solenoid case 110 forms a magnetic path. The case 25 is fitted onto an outer periphery of a left-side end portion of the solenoid case 110 in FIG. 2 (inward end portion in the cylinder radial direction). A gap between the solenoid case 110 and the case 25 is sealed by a seal ring 111 in a liquid-tight manner. The solenoid 110 and the case 25 are joined together by a plurality of (FIG. 2 only shows two) swage portions (crimped portions) 114 that are formed using a swaging jig (not shown).

The overmold 117 is mounted in a cylindrical portion 112 of the solenoid case 110. A gap between an opening portion of the cylindrical portion 112 and the overmold 117 is sealed by a seal ring 113 in a liquid-tight manner. A large diameter portion 132 of the cap member 131 is fitted in an inner flange portion 115 of the solenoid case 110. A gap between the inner flange portion 115 and the cap member 131 is sealed by a seal ring 116 in a liquid-tight manner.

A bobbin 105 covering the coil 102 is provided on an outer peripheral side of the cap member 131. The bobbin 105 is formed of a resin member, such as thermosetting resin, and covers an inner peripheral side of the coil 102 through molding. A small diameter portion 134 of the cap member 131 is fitted in a right-side open end portion of the bobbin 105 in FIG. 2 (outward open end portion in the cylinder radial direction). An insert core 118 is embedded in the bobbin 105 to be located on the inner peripheral side. The bobbin 105 and the insert core 118 have a substantially equal inner diameter. The inner diameters of the bobbin 105 and the insert core 118 are set slightly larger than an outer diameter of a medium diameter portion 133 of the cap member 131.

The plunger 103 is integrally fixed to the actuating rod 106 (shaft portion) and provided so as to be movable in the axial direction on an inner peripheral side of the cap member 131. The plunger 103 is a so-called armature and formed, for example, of ferrous magnetic body to have a bottomed cylinder-like shape. When magnetic force is generated by energization of the coil 102, the plunger 103 is attracted to the core 104 and generates thrust force. The plunger 103 is formed to have outer diameter that is slightly smaller than an inner diameter of the medium diameter portion 133 of the cap member 131 so that the plunger 103 can move in the axial direction within the cap member 131.

The core 104 is a so-called anchor and disposed on the inner peripheral side of the cap member 131. The core 104 includes a boss portion 119 through which the actuating rod 106 extends and a flange portion 120 that is formed in a left-side end portion of the boss portion 119 in FIG. 2 (inward end portion in the cylinder radial direction). The core 104 generates magnetic force in response to the energization of the coil 102, to thereby attract the plunger 103 leftward in FIG. 2 (in a valve-closing direction of the valve body 81).

A recessed portion 121 is provided in a right-side end surface of the boss portion 119 in FIG. 2 (outward end surface in the cylinder radial direction). The plunger 103 attracted to the core 104 enters the recessed portion 121. A bush fitting portion 122 is provided on an inner peripheral side of the core 104. The bush 108 supporting the actuating rod 106 is fitted in the bush fitting portion 122. A conical portion 123 is formed in a right-side end portion of the core 104 in FIG. 2. The conical portion 123 has a shape like a tapered surface that is reduced in diameter toward the plunger 103 side. The conical portion 123 functions to make linear (rectilinear) magnetic characteristics between the core 104 and the plunger 103.

The actuating rod 106 is disposed on an inner peripheral side of the plunger 103, the core 104, and the back-pressure chamber forming member 87. A right-side end portion of the actuating rod 106 in FIG. 2 (opposite-side end portion from a side on which the valve body 81 is mounted; the valve body back-pressure chamber 88 side) is supported to be movable in the axial direction by the bush 107 that is press-fitted in the back-pressure chamber forming member 87. A communication path 124 is formed in the actuating rod 106. The communication path 124 extends through the actuating rod 106 in the axial direction to bring the valve body 81 and the back-pressure chamber forming member 87 into communication. Accordingly, the pilot chamber 71 and the valve body back-pressure chamber 88 come into communication through a rod chamber 125 that is defined by the communication path 124.

A left-side end portion of the actuating rod 106 in FIG. 2 (inward end portion in the cylinder radial direction) is projecting from the core 104. The valve body 81 of the valve mechanism portion 33 is fixed to the projecting end. The valve body 81 is therefore moved (displaced) integrally with the plunger 103 and the actuating rod 106. In other words, the opening degree and valve-opening pressure of the valve body 81 correspond to the thrust force of the plunger 103 which is adjusted by the energization of the coil 102. In other words, the opening and closing of the pilot valve 61 in the valve mechanism portion 33 (damping valve) are carried out by the axial movement of the plunger 103.

The back-pressure chamber forming member 87 comprises a non-magnetic body (non-magnetic material). A cross-section of the back-pressure chamber forming member 87 along a plane surface perpendicular to the axis forms a concentric circle. The back-pressure chamber forming member 87 makes the pressure acting on the valve body 81 relatively low in a state where the valve body back-pressure chamber 88 is filled with the hydraulic fluid that flows into the valve body back-pressure chamber 88 through the communication path 124 (rod chamber 125) of the actuating rod 106. The valve body back-pressure chamber 88 is defined by the back-pressure chamber forming member 87, the actuating rod 106, and the bush 107. Pressure receiving area of the valve body back-pressure chamber 88 is set smaller than pressure receiving area of the valve body 81 receiving hydraulic force between the valve body back-pressure chamber 88 and the seat surface 80.

An orifice 84 (first orifice) is provided at a center of a bottom portion 83 of the valve body 81. The orifice 84 brings the pilot chamber 71 and the rod chamber 125 into communication. This enables pressure propagation to be carried out between the pilot chamber 71 and the valve body back-pressure chamber 88 through the orifice 84 and the rod chamber 125. Area (opening area) of the orifice 84 is set equal to or smaller than area of the disc communication path 78 (third orifice), that is, (area of the first orifice 84)≤(area of the third orifice 78).

A cubic capacity of the valve body back-pressure chamber 88 is approximately one-tenth a cubic capacity of the main back-pressure chamber 45. Therefore, even if the area of the orifice 84 (first orifice) is set equal to the area of the disc communication path 78 (third orifice), a velocity at which pressure is propagated from the pilot chamber 71 through the orifice 84 and the rod chamber 125 to the valve body back-pressure chamber 88 (hereinafter referred to as rod propagation velocity) is not decreased to be lower than a velocity at which pressure is propagated from the pilot chamber 71 through the disc communication path 78 to the main back-pressure chamber 45 (hereinafter referred to as main propagation velocity).

Operation of the first embodiment will be discussed below.

When the coil 102 is not being energized, the valve body 81 is biased by the pilot spring 68 in the rightward direction in FIG. 2 (valve-opening direction), and the spring receiving portion 82 of the valve body 81 is brought into abutment against (seated on) the fail-safe disc 94. When the coil 102 is being energized, thrust force acting in the leftward direction in FIG. 2 (valve-closing direction of the valve body 81) is generated in the plunger 103. This causes the actuating rod 106 (shaft portion) to move in the leftward direction in FIG. 2 against the biasing force of the pilot spring 68.

In a soft mode where a current value of energization of the coil 102 is small, the biasing force of the pilot spring 68 and the thrust force of the plunger 103 are compensated, which makes the pilot valve 61 open by a given valve-opening amount (valve-opening amount for soft characteristics). At this time, the pressure of the valve body back-pressure chamber 88, or the pressure of the pilot chamber 71 which is propagated through the orifice 84 and the rod chamber 125, is received by an end surface 109 of the actuating rod 106, to thereby generate assist thrust acting to assist the thrust force of the plunger 103. The assist thrust enables the valve-opening pressure of the pilot valve 61 to increase even if the thrust force generated by the plunger 103 is small. This means that the current value of the energization of the coil 102 can be reduced, which makes it possible to achieve a power reduction in the damping force adjustment mechanism 31.

During an extension stroke, the disc valve 14 of the piston 5 is closed due to a pressure increase in the cylinder's upper chamber 2A. Before the disc valve 13 is opened, the hydraulic liquid on the cylinder's upper chamber 2A side is pressurized. The pressurized hydraulic liquid flows through the path 22, the annular flow path 21, the connection port 23, and the joint member 28 to be introduced into the damping force adjustment mechanism (pressure adjustment valve) 31. At this time, the hydraulic liquid of an equivalent amount to the movement of the piston 5 opens the disc valve 17 of the base valve 10 and then flows out of the reservoir 4 into the cylinder's lower chamber 2B. When the pressure in the cylinder's upper chamber 2A reaches the valve-opening pressure of the disc valve 13 of the piston 5 and opens the disc valve 13, the pressure in the cylinder's upper chamber 2A is relieved into the cylinder's lower chamber 2B. The pressure in the cylinder's upper chamber 2A is thus prevented from being excessively increased.

During a compression stroke, the disc valve 14 of the piston 5 is opened due to a pressure increase in the cylinder's lower chamber 2B, and the disc valve 17 of the extension-side path 15 of the base valve 10 is closed. Before the disc valve 18 is opened, the hydraulic liquid in the piston's lower chamber 2B flows into the cylinder's upper chamber 2A, and the hydraulic liquid of an equivalent amount to a volume of a portion of the piston rod 6 which enters the cylinder 2 flows out of the cylinder's upper chamber 2A, passes through the path 22, the annular flow path 21, the connection port 23, and the flow path 36, and is introduced into the damping force adjustment mechanism 31. When the pressure in the cylinder's lower chamber 2B reaches the valve-opening pressure of the disc valve 18 of the base valve 10 and opens the disc valve 18, the pressure in the cylinder's lower chamber 2B is relieved into the reservoir 4. This prevents the pressure in the cylinder's lower chamber 2B from being excessively increased.

The hydraulic liquid that is introduced into the damping force adjustment mechanism 31 passes through the introduction orifice 65, the pilot chamber 71, the recessed portion 77, and the path 72, opens the flexible disc 69, and is introduced into the main back-pressure chamber 45. Before the main valve 41 is opened (when piston velocity is in a low velocity region), the hydraulic liquid that flows into the recessed portion 77 passes through the pilot spring 68, the fail-safe disc 94, the washer 97, the path 99 formed in the cap 98, the outer peripheral flow path 35 of the valve mechanism portion 33, and the plurality of paths 27 formed in the inner flange portion 26 of the case 25 to flow into the reservoir 4.

When the pressure of the hydraulic liquid that is introduced into the annular path 48 through the annular fluid path 21, the flow path 36, and the path 50 reaches a given pressure (valve-opening pressure) due to increase of the piston velocity and opens the main valve 41, the hydraulic liquid introduced into the annular path 48 passes through the outer peripheral flow path 35 of the valve mechanism portion 33 and the plurality of paths 27 formed in the inner flange portion 26 of the case 25 to flow into the reservoir 4.

As discussed above, during both the extension and compression strokes of the piston rod 6, the damping force adjustment mechanism 31 generates damping force that is created by the hydraulic liquid passing through the introduction orifice 65 and the pilot valve 61 before the main valve 41 is opened (when the piston velocity is in the low velocity region). After the main valve 41 is opened (when the piston velocity is in a middle velocity region), the damping force adjustment mechanism 31 generates damping force corresponding to the opening degree of the main valve 41. At this time, the damping force generated by the damping force adjustment mechanism 31 can be directly adjusted by controlling the energization of the coil 102 of the solenoid 101 and thus adjusting the valve-opening pressure of the pilot valve 61.

If the thrust force of the plunger 103 is lost at occurrence of a failure, such as disconnection of the coil 102 and malfunction of an in-vehicle controller, the valve body 81 is moved in the rightward direction in FIG. 2 (valve-opening direction of the valve body 81) by the biasing force of the pilot spring 68 (which also serves as a fail-safe spring), to thereby open the pilot valve 61. At the same time, the spring receiving portion 82 of the valve body 81 is brought into abutment against the fail-safe disc 94, to thereby interrupt the communication between a flow path (reference sign omitted) on the inner side of the valve mechanism portion 33 and the flow path 35 on the outer side of the valve mechanism portion 33.

In the aforementioned manner, the valve-opening pressure of the fail-safe valve 91 is adjusted to control the flow of the hydraulic liquid flowing from the annular fluid path 21 through the flow path 36 of the joint member 28, the introduction orifice 65 of the pilot pin 63, the pilot chamber 71, the recessed portion 77 of the pilot body 62, an axial hole of the washer 97, the path 99 (notch) formed in the cap 98, the outer peripheral flow path 35 of the valve mechanism portion 33, and the plurality of paths 27 formed in the inner flange portion 26 of the case 25 into the reservoir 4. This makes it possible to generate a constant amount of damping force even at the occurrence of a failure. Furthermore, it is possible to adjust the inner pressure of the main back-pressure chamber 45, therefore the valve-opening pressure of the main valve 41, and thus obtain a constant amount of damping force even if a failure occurs.

According to a conventional damping force adjustable shock absorber, when the pressure in a pilot chamber reaches a given pressure (valve-opening pressure) and opens a pilot valve, hydraulic liquid flows out of the pilot chamber, passes through an outer peripheral flow path of a valve mechanism portion, and flows into a reservoir. If the flow rate of the hydraulic liquid flowing out of the pilot chamber is increased, the pilot valve makes self-induced vibrations (fluid-induced vibrations) in some cases. Such self-induced vibrations (chattering) of the pilot valve cause the noises generated by a damping force adjustable shock absorber.

In contrast to the conventional damping force adjustable shock absorber, the damping force adjustable shock absorber of the first embodiment is so configured that the orifice 84 (first orifice) is provided in the bottom portion 83 of the valve body 81, and the hydraulic liquid is transferred between the pilot chamber 71 and the valve body back-pressure chamber 88 (rod chamber 125) via the orifice 84.

According to the first embodiment, when the operation of the pilot valve 61 causes the actuating rod 106 (shaft portion) formed integrally with the valve body 81 to move in the axial direction, the hydraulic liquid of an equivalent amount to a volume of a portion of the actuating rod 106 which enters and retracts from the valve body back-pressure chamber 88 moves between the pilot chamber 71 and the valve body back-pressure chamber 88 (rod chamber 125) through the orifice 84 (volume compensation). At this time, the damping that is generated by the hydraulic fluid passing through the orifice 84 acts on the valve body 81, which restrains the self-induced vibrations (chattering) of the pilot valve 61.

In the first embodiment, since the valve body back-pressure chamber 88 is in communication with the pilot chamber 71 via the orifice 84 (first orifice) and the rod chamber 125, the rod chamber 125 is under higher pressure, as compared to a downstream pressure of the pilot valve 61 (pressure at the recessed portion 77 of the pilot body 62).

Consequently, air bubbles generated in the flow path on the downstream side of the pilot valve 61 do not enter the rod chamber 125 through the orifice 84, which restrains air accumulation from being generated in the valve body back-pressure chamber 88 that is in communication with the rod chamber 125. This makes it possible to restrain a reduction in volume elasticity coefficient of the hydraulic liquid, which is attributed to the air accumulation, and also restrain insufficiency of the hydraulic liquid and deterioration in responsiveness at the volume compensation.

### Second Embodiment

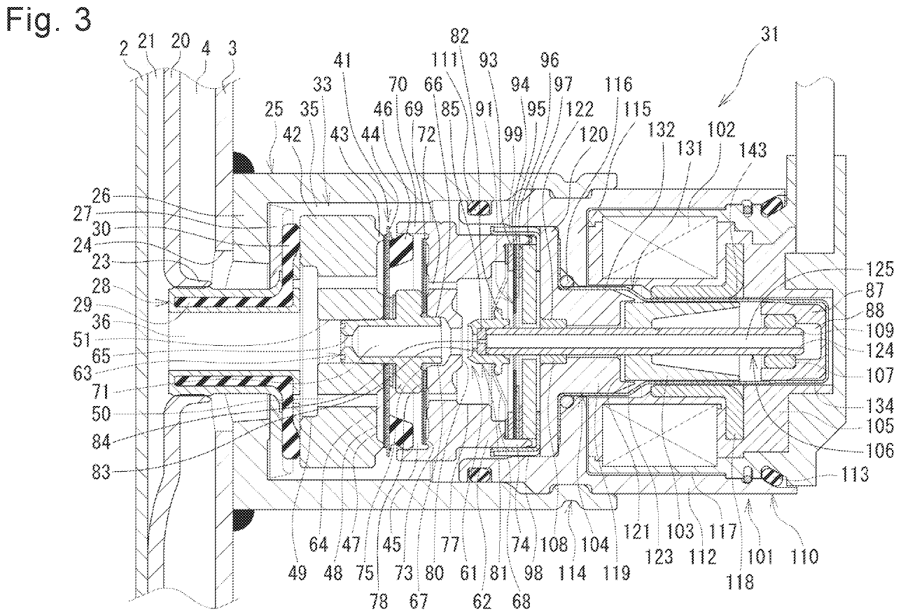

A second embodiment will be now discussed with reference to FIG. 3. The discussion explains different part from the first embodiment. The same terms and reference signs are used for common elements with the first embodiment, and overlapping explanations are omitted.

According to the first embodiment, the orifice 84 (first orifice) is provided at the center of the bottom portion 83 of the valve body 81, and the hydraulic liquid is transferred between the pilot chamber 71 and the rod chamber 125 through the orifice 84.

In the second embodiment, a washer 85 is interposed between a bottom portion 83 of a valve body 81 and an actuating rod 106 (shaft portion), and an orifice 84 (first orifice) is provided at a center of the washer 85.

The second embodiment makes it possible to obtain equivalent operation and effects to the first embodiment.

Since the second embodiment does not require forming the orifice 84 (first orifice) in the valve body 81, the valve body 81 is easy to be fabricated.

According to the second embodiment, furthermore, the valve body 81 of the same type is applicable even if the orifice 84 (first orifice) is specified to have different dimensions. This facilitates parts management and also reduces manufacturing cost.

### Third Embodiment

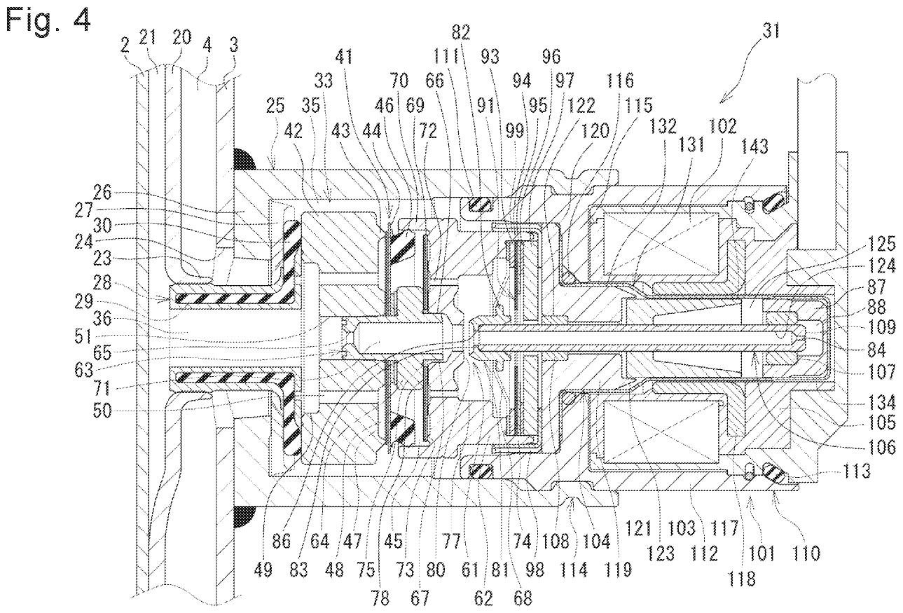

A third embodiment will be discussed below with reference to FIG. 4. The discussion explains different part from the first embodiment. The same terms and reference signs are used for common elements with the first embodiment, and overlapping explanations are omitted.

According to the first embodiment, the orifice 84 (first orifice) is provided at the center of the bottom portion 83 of the valve body 81, and the hydraulic liquid is transferred between the pilot chamber 71 and the rod chamber 125 through the orifice 84.

In the third embodiment, an orifice 84 (first orifice) is provided in an end portion of an actuating rod 106 which is located on a valve body back-pressure chamber 88 side (opposite end portion from a side on which a valve body 81 is mounted), and hydraulic liquid is transferred between a rod chamber 125 and the valve body back-pressure chamber 88 through the orifice 84.

As illustrated in FIG. 4, formed in a bottom portion 83 of the valve body 81 is a communication path 86 as in a valve body of a conventional damping force adjustable shock absorber, namely, the communication path 86 having substantially the same diameter as a communication path 124. This makes the rod chamber 125 equal in inner pressure to the pilot chamber 71.

According to the third embodiment, when a pilot valve 61 operates to axially move the actuating rod 106 to which the valve body 81 is fixed, the hydraulic liquid of an equivalent amount to a volume of a portion of the actuating rod 106 which enters and retracts from the valve body back-pressure chamber 88 moves between the rod chamber 125 (pilot chamber 71) and the valve body back-pressure chamber 88 through the orifice 84 (volume compensation). At this time, the damping that is generated by the hydraulic liquid passing through the orifice 84 acts on the valve body 81, which restrains the self-induced vibrations (chattering) of the pilot valve 61.

The invention is not limited to the above-discussed embodiments and may be modified in various ways. For example, the embodiments are intended to describe the invention in detail for easy understanding and do not necessarily have to include all the configurations mentioned above. The configuration of each embodiment may be partially replaced with another configuration or incorporated with another configuration. It is also possible to incorporate, omit or replace a part of the configuration of one of the embodiments into, from or with the configuration of another one of the embodiments.

The present application claims priority under Japanese Patent Application No. 2021-183426 filed on Nov. 10, 2021. The entire disclosure of Japanese Patent Application No. 2021-183426 filed on Nov. 10, 2021 including the description, claims, drawings and abstract, is incorporated herein by reference in its entirety.

### REFERENCE SIGN LIST

1: Damping force adjustable shock absorber, 2: Cylinder, 5: Piston, 31: Damping force adjustment mechanism (pressure control valve), 41: Main valve, 45: Main back-pressure chamber, 80: Seat surface, 81: Valve body, 84: Orifice (first orifice), 88: Valve body back-pressure chamber, 101: Solenoid, 106: Actuating rod (shaft portion)

1. A damping force adjustable shock absorber comprising:
a cylinder in which hydraulic fluid is sealingly contained;
a piston that is slidably fitted in the cylinder;
a flow path in which a hydraulic fluid flow is generated by a sliding motion of the piston fitted in the cylinder, and
a pressure control valve that is provided in the flow path, the pressure control valve in which valve-opening pressure of a damping valve is adjusted by thrust force that is generated by a solenoid,
the damping valve comprising:
a main valve configured to control the hydraulic fluid flow passing through the flow path to generate damping force;
a main back-pressure chamber configured to make inner pressure act on the main valve in a valve-closing direction, and
a pilot valve including a valve body that is seated on a seat surface and configured to adjust valve-opening pressure of the main valve,
the solenoid comprising:
a shaft portion that is provided in the valve body and provided inside with a communication path extending in an axial direction;
a plunger in which the shaft portion is inserted, the plunger being configured to generate thrust force biasing the valve body toward the seat surface side in response to energization of a coil, and
a valve body back-pressure chamber configured to make inner pressure act in a direction biasing the valve body toward the seat surface side,
wherein a first orifice is provided between the valve body back-pressure chamber and the valve body.

2. The damping force adjustable shock absorber according to claim 1, comprising:
a second orifice configured to introduce fluid from an upstream side of the main valve toward the main back-pressure chamber side, and
a third orifice provided downstream of the second orifice and configured to introduce a part of a fluid flow into the main back-pressure chamber,
wherein a formula, (area of the first orifice)≤(area of the third orifice), is established.

3. The damping force adjustable shock absorber according to claim 1,
wherein the first orifice is formed in a bottom portion of the valve body.

4. The damping force adjustable shock absorber according to claim 1,
wherein the first orifice is formed in a washer that is interposed between a bottom portion of the valve body and the shaft portion.

5. The damping force adjustable shock absorber according to claim 1,
wherein the first orifice is formed in a valve body back-pressure chamber-side end portion of the shaft portion.

6. A damping valve configured to be adjusted in valve-opening pressure by thrust force generated by a solenoid,
the damping valve comprising:
a main valve configured to control a hydraulic fluid flow to generate damping force;
a main back-pressure chamber configured to make inner pressure act on the main valve in a valve-closing direction, and
a pilot valve including a valve body that is seated on a seat surface and configured to adjust valve-opening pressure of the main valve,
the solenoid comprising:
a shaft portion that is provided in the valve body and provided inside with a communication path extending in an axial direction;
a plunger in which the shaft portion is inserted, the plunger being configured to generate thrust force biasing the valve body toward the seat surface side in response to energization of a coil, and
a valve body back-pressure chamber configured to make inner pressure act in a direction biasing the valve body toward the seat surface side,
wherein a first orifice is provided between the valve body back-pressure chamber and the valve body.

7. A solenoid configured to adjust valve-opening pressure of a damping valve,
the damping valve comprising a main valve configured to control a hydraulic fluid flow to generate damping force, a main back-pressure chamber configured to make inner pressure act on the main valve in a valve-closing direction, and a pilot valve including a valve body that is seated on a seat surface and configured to adjust valve-opening pressure of the main valve,
the solenoid comprising:
a shaft portion provided in the valve body and provided inside with a communication path extending in an axial direction;
a plunger in which the shaft portion is inserted, the plunger being configured to generate thrust force biasing the valve body toward the seat surface side in response to energization of a coil, and
a valve body back-pressure chamber configured to make inner pressure act in a direction biasing the valve body toward the seat surface side,
wherein a first orifice is provided between the valve body back-pressure chamber and the valve body.
